(19) United States
(12) Patent Application Publication
(10) Pub. No.: US 2018/0104930 A1
(43) Pub. Date: Apr. 19, 2018

(54) METAL ARTICLES WITH HEAT LAMINATED CLEAR SEMI-CRYSTALLINE POLYESTERS

(71) Applicant: Eastman Chemical Company, Kingsport, TN (US)

(72) Inventors: Xue Guang Steven Lin, Shanghai (CN); Fan Liang Meng, Shanghai (CN); Zhong Zhong Johnny Qian, Shanghai (CN); Yu-Hwey Chuang, Kaohsiung (TW); Emmett Dudley Crawford, Kingsport, TN (US); Michael Eugene Donelson, Kingsport, TN (US); Steven Lee Stafford, Gray, TN (US); James Carl Williams, Blountville, TN (US)

(73) Assignee: Eastman Chemical Company, Kingsport, TN (US)

(21) Appl. No.: 15/783,141

(22) Filed: Oct. 13, 2017

Related U.S. Application Data
(60) Provisional application No. 62/408,948, filed on Oct. 17, 2016.

(51) Int. Cl. B32B 15/09; C08G 63/199; C08J 5/18; B29C 47/00; B29C 55/00; B29C 55/12; B32B 37/06; B32B 38/00

(52) U.S. Cl. CPC B32B 15/09; C08G 63/199; C08J 5/18; B29C 47/0004; B29C 47/0021; B29C 47/0057; B29K 2067/00; B29C 55/12; B32B 37/06; B32B 38/0036; C08J 2367/02; B32B 2307/704; B32B 2038/0048; B29C 55/005

(57) ABSTRACT

This invention relates to clear, semicrystalline, strain induced crystallized polyester films heat laminated onto metal substrates. The films contain at least one polyester which comprises at least of one or more monomers selected from 1,4-cyclohexanedimethanol or 2,2,4,4-tetramethyl-1,3-cyclobutanediol. The articles of the present invention exhibit enhanced mechanical properties useful for the fabrication of thin metal articles such as metal cans.

### BACKGROUND

### 1. Field of the Invention

The present invention generally relates to films comprising polyester resin compositions useful for laminating and coating metal substrates including thin metal substrates useful in the manufacture of metal cans, drawn can, drawn-redraws cans and can lids. The present invention relates to articles made from clear, semicrystalline, strain induced crystallized polyesters films heat laminated onto metal substrates. The polyesters of the present invention comprise (A) a dicarboxylic acid component comprising either: i) a) 70 to 100 mole % of aromatic dicarboxylic acid residues having up to 20 carbon atoms; b) 0 to 30 mole % of one or more secondary aromatic dicarboxylic acid residues having up to 20 carbon atoms; and c) 0 to 30 mole % of one or more secondary aliphatic dicarboxylic acid residues having up to 16 carbon atoms; or ii) a) 0 to 30 mole % of one or more aromatic dicarboxylic acid residues having up to 20 carbon atoms; b) 70 to 100 mole % of one or more secondary aliphatic dicarboxylic acid residues having up to 16 carbon atoms; and (B) a glycol component comprising: i) 70 to 100 mole % of a glycol having up to 16 carbon atoms; ii) 0 to 30 mole % of one or more secondary glycols having up to 16 carbon atoms; and wherein the total mole % of the dicarboxylic acid component is 100 mole %, and the total mole % of the glycol component is 100 mole %. The inherent viscosity of the polyesters in the present invention is 0.35 to 1.2 dL/g. These polyesters have a combination of certain crystallization rates along with a certain melting temperatures (Tₘ) and certain glass transition temperatures (T_{g}). The polyester film provides excellent adhesion and bonding strength between the polyester films and metal substrates. The articles of the present invention exhibit improved moisture and corrosion resistance, acid retort, and dent resistance. The articles also exhibit enhanced mechanical properties useful for the fabrication of thin metal substrates, such as metal cans and food and beverage containers.

### 2. Background of the Invention

The present invention relates to the manufacture of laminated thin metal substrates suitable for use in metal packaging applications. The films made using the polyester resin compositions of the present invention can be utilized to laminate any metal substrates including metal substrates suitable for use in metal packaging applications such as food and beverage cans. For example, the articles of the present invention can be used as containers for the distribution or storage of goods including thin metal substrates or used for making metal cans. The metal substrates suitable for use in the present invention include any metal suitable for use in packaging applications including aluminum, tin, steel, tinplate, tin-free plate, tin plate steel (tin-coated steel), and tin-free steel. The polyester films of the present invention can be laminated onto metal substrates on one or both sides and then subsequently drawn into metal cans. The metal cans according to the present invention are suitable for use as food or beverage cans. For example, the present invention is useful for the manufacture of 2-piece cans via a draw-redraw metal forming process. In another aspect, the present invention relates to the use of an extrusion coated or film laminated metal laminates that can be used as the can body feed stock in a drawn or drawn-redrawn can forming process.

Metal cans of various types and sizes find widespread commercial use in packaging applications including a wide variety of packaging for foods and beverages. In such food and beverage packaging usage, it is generally desired to avoid direct contact between the food or beverage to be packaged and the metal substrate from which the container is manufactured. As such, metal cans for food and beverage packaging are typically coated on at least their interior surfaces with a coating of a relatively inert organic substance, such as an epoxy resin or a phenol resin in a solvent.

Historically, such organic can coatings were typically deposited or applied from relatively low solids organic solvent-based solutions. However, in more recent times, environmental concerns and regulations requiring substantial reductions in airborne emissions from various industrial facilities have prompted a need for can coatings and can coating processes involving substantially less organic solvent usage and less potential for undesired airborne organic solvent emissions.

In view of the foregoing, it is an object of the present invention to provide an improvement in the manufacture of food or beverage cans by eliminating the need for the use of organic solvent--based coatings. The present invention provides a means by which metal containers can be manufactured from films laminated or extruded unto metal substrates with good retort resistance.

The term “retort” as herein as used is typically applied to containers filled with a food product or a beverage which is sterilized and processed by immersion of the filled containers in a hot bath maintained at an elevated temperature of about 121° C. for a prolonged period of time such as, for example, thirty minutes or one hour or longer.

These and other objectives are achieved in accordance with the present invention by the use of a metal substrate laminated or extrusion coated with single layer polyester films or multilayered polyester films adhered to at least one surface thereof comprising (A) a dicarboxylic acid component comprising either: i) a) 70 to 100 mole % of aromatic dicarboxylic acid residues having up to 20 carbon atoms; b) 0 to 30 mole % of one or more secondary aromatic dicarboxylic acid residues having up to 20 carbon atoms; and c) 0 to 30 mole % of one or more secondary aliphatic dicarboxylic acid residues having up to 16 carbon atoms; or ii) a) 0 to 30 mole % of one or more aromatic dicarboxylic acid residues having up to 20 carbon atoms; b) 70 to 100 mole % of one or more secondary aliphatic dicarboxylic acid residues having up to 16 carbon atoms; and (B) a glycol component comprising: i) 70 to 100 mole % of a glycol having up to 16 carbon atoms; ii) 0 to 30 mole % of one or more secondary glycols having up to 16 carbon atoms; and wherein the total mole % of the dicarboxylic acid component is 100 mole %, and the total mole % of the glycol component is 100 mole %, wherein the inherent viscosity of the polyester is 0.35 to 1.2 dL/g.

The metal substrates suitably employed in the practice of the present invention include any metal sheet materials that exhibit good adhesion to the polyester films of the present invention that is directly bonded thereto. Examples of such suitable metal sheet materials include those types of chemically or electrochemically coated (e.g., electrolytically plated) steel sheetstocks already known in the art to be useful in the manufacture of cans including food and beverage containers. For example, in some embodiments of the present invention, the metal substrate employed is a non-ferrous metal coated steel sheet such as chromium/chromium oxide coated steel (also commonly referred to in the art as chrome/chrome oxide coated steel, tin-free steel and as electrolytically chrome coated steel or “ECCS”) that has a composite coating of chrome and chrome oxide on both major planar surfaces of said metal substrate and various species or versions of which are well known in the art. In other embodiments, suitable metal substrates include aluminum, tin, steel, tin plate, tin plate steel, tin-free plate, surface-treated steel plate, aluminum plate, electrolytic chrome-coated steel plate, nickeled steel plate, galvanized steel plate, aluminum plate, or aluminum alloy plate.

The thickness of the metal substrate employed in the practice of the present invention corresponds to that employed in conventional can manufacturing operations. For example, in drawn, drawn-redrawn processes, the metal substrate is in the range of from about 100 to about 500 um. By further example, such thickness can be in the range of from about 100 to about 400 um or from about 250 to about 350 um.

In the present invention, the thickness of each of the polyester film layers is typically from about 1 to about 300 um. For example, from about 1 to about 200 um, or from about 1 to about 100 um or from about 5 to about 50 um.

In the multilayer film embodiments of the present invention, the inner and outer film layers can be applied separately or simultaneously either by coextrusion or by lamination of a previously prepared multilayered film. For example, the individual films of the multilayered films extrusions are applied simultaneously by either coextrusion or multilayer film lamination techniques.

In some embodiments, regardless of how the above-noted multilayered films are applied, resulting laminate undergoes to a post-heating treatment prior to the can forming draw or draw-redraw step at a temperature above the crystalline melting point of the highest melting polyester resin employed in said multilayered films. The post-heating treatment is for a short period of time such as, for example, for a period of about 5 minutes or less. The post-heating procedure is generally conducted at a temperature greater than from about 220° to about 265° C. and for a period of time from about 0.2 to about 5 minutes.

The use of the present multilayer film on a metal substrate or in a metal can is conducted pursuant to conventional draw or draw-redraw can forming techniques during the actual can forming operations, and such operations can consist of either a single draw or multiple drawing steps depending upon the ultimate depth of draw (or draw ratio) required for the particular type of can to be formed in such operation.

The formation of cans, for example drawn cans, imparts a high degree of stress to the container article and a significant amount of unrelieved residual stress can remain in the polyester film employed on such a laminated article following such can body formation. It is therefore important in the practice of the present invention that the film layers employed have sufficient strength and adhesion at ambient temperatures to withstand such residual stresses without coating failure during ambient temperature storage of foods and beverages therein. In addition, since food and/or beverage canning operations often involve processing at elevated temperatures (e.g., such as steam processing at about 121° C.) for prolonged periods of time (e.g., as much as an hour or more), it is similarly important that the polyester film layer employed have sufficient strength and adhesion to avoid coating failure under such elevated temperatures.

### SUMMARY

One embodiment of the present invention is an article comprising a clear, semicrystalline, strain induced crystallized polyester film heat laminated onto a metal substrate, wherein the film comprises at least one polyester which comprises:

(A) A dicarboxylic acid component comprising either:
i)
   a) 70 to 100 mole % of aromatic dicarboxylic acid residues having up to 20 carbon atoms;
   b) 0 to 30 mole % of one or more secondary aromatic dicarboxylic acid residues having up to 20 carbon atoms; and
   c) 0 to 30 mole % of one or more secondary aliphatic dicarboxylic acid residues having up to 16 carbon atoms; or
ii)
   a) 0 to 30 mole % of one or more aromatic dicarboxylic acid residues having up to 20 carbon atoms;
   b) 70 to 100 mole % of one or more secondary aliphatic dicarboxylic acid residues having up to 16 carbon atoms; and

(B) A glycol component comprising:
i) 70 to 100 mole % of a glycol having up to 16 carbon atoms
ii) 0 to 30 mole % of one or more secondary glycols having up to 16 carbon atoms; and

wherein the total mole % of the dicarboxylic acid component is 100 mole %, and the total mole % of the glycol component is 100 mole %;

wherein the inherent viscosity of the polyester is 0.35 to 1.2 dL/g as determined in 60/40 (wt/wt) phenol/tetrachloroethane at a concentration of 0.5 g/100 ml at 25° C.;

wherein said polyester has a T_{g} of 55 to 120° C.; and

wherein said film has a strain induced strain induced crystallinity of 5 to 30% when stretched at a temperature above the T_{g} of the polyester.

Another embodiment of the present invention is an article comprising a multilayered clear, semicrystalline, strain induced crystallized strain induced crystallized polyester film heat laminated onto a metal substrate, wherein the first layer of the film comprises at least one polyester which comprises:

(A) a dicarboxylic acid component comprising either:
i)
   a) 70 to 100 mole % of aromatic dicarboxylic acid residues having up to 20 carbon atoms;
   b) 0 to 30 mole % of one or more secondary aromatic dicarboxylic acid residues having up to 20 carbon atoms; and
   c) 0 to 30 mole % of one or more secondary aliphatic dicarboxylic acid residues having up to 16 carbon atoms; or
ii)
   a) 0 to 30 mole % of one or more aromatic dicarboxylic acid residues having up to 20 carbon atoms;
   b) 70 to 100 mole % of one or more secondary aliphatic dicarboxylic acid residues having up to 16 carbon atoms; and

(B) a glycol component comprising:
i) 70 to 100 mole % of a glycol having up to 16 carbon atoms
ii) 0 to 30 mole % of one or more secondary glycols having up to 16 carbon atoms; and

wherein the total mole % of the dicarboxylic acid component is 100 mole %, and the total mole % of the glycol component is 100 mole %;

wherein the inherent viscosity of the polyester is 0.35 to 1.2 dL/g as determined in 60/40 (wt/wt) phenol/tetrachloroethane at a concentration of 0.5 g/100 ml at 25° C.;

wherein said polyester has a T_{g} of 55 to 120° C.; and

wherein said film has a strain induced strain induced crystallinity of 5 to 30% when stretched at a temperature above the T_{g} of the polyester when stretched at temperature above the T_{g} of the polyester;

and wherein the second layer comprises polyesters, polyesters other than those of the first layer, PETG, PBT, PP and mixtures thereof and wherein the optional third layer comprises polyesters, polyesters other than those of the first layer, PET, PCT, PBT, PP, PEN, PETG and mixtures thereof.

In another embodiment with multilayered films, the article comprises a multilayered clear, semicrystalline, strain induced crystallized strain induced crystallized polyester film heat laminated onto a metal substrate, wherein the first layer of the film comprises at least one polyester which comprises:

(A) a dicarboxylic acid component comprising either:
i)
   a) 70 to 100 mole % of aromatic dicarboxylic acid residues having up to 20 carbon atoms;
   b) 0 to 30 mole % of one or more secondary aromatic dicarboxylic acid residues having up to 20 carbon atoms; and
   c) 0 to 30 mole % of one or more secondary aliphatic dicarboxylic acid residues having up to 16 carbon atoms; or
ii)
   a) 0 to 30 mole % of one or more aromatic dicarboxylic acid residues having up to 20 carbon atoms;
   b) 70 to 100 mole % of one or more secondary aliphatic dicarboxylic acid residues having up to 16 carbon atoms; and

(B) a glycol component comprising:
i) 70 to 100 mole % of a glycol having up to 16 carbon atoms
ii) 0 to 30 mole % of one or more secondary glycols having up to 16 carbon atoms; and

wherein the total mole % of the dicarboxylic acid component is 100 mole %, and the total mole % of the glycol component is 100 mole %;

wherein the inherent viscosity of the polyester is 0.35 to 1.2 dL/g as determined in 60/40 (wt/wt) phenol/tetrachloroethane at a concentration of 0.5 g/100 ml at 25° C.;

wherein said polyester has a T_{g} of 55 to 120° C.; and

wherein said film has a strain induced strain induced crystallinity of 0 to 30% when stretched at a temperature above the T_{g} of the polyester; and

wherein the second layer comprises, polyester, the polyesters of the first layer; polyesters other than those of the first layer; PET(G)-100 mole % terephthalic acid as the acid component and 50 to 99 mole % EG and 1 to 50 mole % CHDM as the glycol component; polybutylene terephthalate or polyesters comprising 100 mole % terephthalic acid as the diacid component and 100 mole % 1,4-butanediol as the glycol component, polypropylene, and mixtures thereof and wherein the second layer has a strain induced strain induced crystallinity of 5 to 30% when stretched at a temperature above the T_{g} of the polyester; and

wherein the optional third layer comprises polyesters, polyesters of the first layer; polyesters other than those of the first layer, polyethylene terephthalate or polyesters comprising 100 mole % terephthalic acid as the diacid component and 100 mole % ethylene glycol as the glycol component, polybutylene terephthalate or polyesters comprising 100 mole % terephthalic acid as the diacid component and 100 mole % 1,4-butanediol as the glycol component, polypropylene, polyethylene naphthalate or polyesters comprising 100 mole % 2,6-naphthalene dicarboxylic acid as the diacid component and 100 mole % ethylene glycol as the glycol component; PCT or polyesters comprising 100 mole % terephthalic acid as the diacid component and 50 to 99 mole % CHDM and 1 to 50 mole % EG as the glycol component; PETG or polyesters comprising 100 mole % terephthalic acid as the diacid component and 50 to 99 mole % EG and 1 to 50 mole % CHDM as the glycol component; or polyesters comprising 100 mole % terephthalic acid as the diacid component and 10 to 50 mole % EG and 40 to 60 mole % CHDM as the glycol component, and 1 to 30 mole % isosorbide as the glycol component and mixtures thereof and wherein the strain induced crystallinty of the third layer is 5 to 30% when stretched at a temperature above the T_{g} of the polyester.

Another embodiment of the present invention is a process for making a laminate of a metal substrate and a sem icrystalline, strain induced crystallized polyester, comprising the steps of:
1) melt compounding one or more polyester(s) at a temperature of about 250° C. to about 290° C., wherein at least one polyester which comprises:
   (A) a dicarboxylic acid component comprising either:
      i)
         a) 70 to 100 mole % of aromatic dicarboxylic acid residues having up to 20 carbon atoms;
         b) 0 to 30 mole % of one or more secondary aromatic dicarboxylic acid residues having up to 20 carbon atoms; and
         c) 0 to 30 mole % of one or more secondary aliphatic dicarboxylic acid residues having up to 16 carbon atoms; or
      ii)
         a) 0 to 30 mole % of one or more aromatic dicarboxylic acid residues having up to 20 carbon atoms;
         b) 70 to 100 mole % of one or more secondary aliphatic dicarboxylic acid residues having up to 16 carbon atoms; and
   (B) a glycol component comprising:
i) 70 to 100 mole % of a glycol having up to 16 carbon atoms
ii) 0 to 30 mole % of one or more secondary glycols having up to 16 carbon atoms; and

wherein the total mole % of the dicarboxylic acid component is 100 mole %, and the total mole % of the glycol component is 100 mole %;

wherein the inherent viscosity of the polyester is 0.35 to 1.2 dL/g as determined in 60/40 (wt/wt) phenol/tetrachloroethane at a concentration of 0.5 g/100 ml at 25° C.; and

wherein said polyester has a T_{g} of 55 to 120° C.;
2) extruding the melt compounded polyester(s) at a temperature of about 250° C. to about 290° C.,
3) bi-axially stretching the extruded films to different draw ratios (MD*TD), at a temperature above the T_{g} of the film, and at a strain rate of 100%-300% per second,
4) heating the metal substrate to a temperature above the T_{g} of the film,
5) applying the film to a least one surface of the metal substrate under a pressure of 0.5-30 MPa and at a temperature of 210-270° C.,
6) heating the laminate so that the film is raised to a temperature above its T_{g} or close to its Tₘ, and holding at such elevated temperature,
7) quenching rapidly the heated laminate to a temperature below the T_{g} of the polyester,
8) providing a laminate comprising a metal substrate and monolayer film of biaxially-oriented polyester having a semi-crystalline structure.

### DETAILED DESCRIPTION

The present invention may be understood more readily by reference to the following detailed description of certain embodiments of the invention and the working examples. In accordance with the purpose(s) of this invention, certain embodiments of the invention are described in the Summary of the Invention and are further described herein below. Also, other embodiments of the invention are described herein.

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds. Typically, the difunctional carboxylic acid can be a dicarboxylic acid and the difunctional hydroxyl compound can be a dihydric alcohol such as, for example, glycols and diols. The term “glycol” as used in this application includes, but is not limited to, diols, glycols, and/or multifunctional hydroxyl compounds, for example, branching agents. Alternatively, the difunctional carboxylic acid may be a hydroxy carboxylic acid such as, for example, p-hydroxybenzoic acid, and the difunctional hydroxyl compound may be an aromatic nucleus bearing 2 hydroxyl substituents such as, for example, hydroquinone. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through a carbonyloxy group. Thus, for example, the dicarboxylic acid residues may be derived from a dicarboxylic acid monomer or its associated acid halides, esters, salts, anhydrides, or mixtures thereof. As used herein, therefore, the term dicarboxylic acid is intended to include dicarboxylic acids and any derivative of a dicarboxylic acid, including its associated acid halides, esters, half-esters, salts, half-salts, anhydrides, mixed anhydrides, or mixtures thereof, useful in a reaction process with a diol to make polyester. Furthermore, as used in this application, the term “diacid” includes multifunctional acids, for example, branching agents. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, or mixtures thereof or residues thereof useful in a reaction process with a diol to make polyester.

In one embodiment, terephthalic acid may be used as the starting material. In another embodiment, dimethyl terephthalate may be used as the starting material. In another embodiment, terephthalic acid, derivatives of terephthalic acid and mixtures thereof may be used. In yet another embodiment, mixtures of terephthalic acid and dimethyl terephthalate may be used as the starting material and/or as an intermediate material.

The polyesters used in the present invention typically can be prepared from dicarboxylic acids and diols which react in substantially equal proportions and are incorporated into the polyester polymer as their corresponding residues. The polyesters of the present invention, therefore, can contain substantially equal molar proportions of acid residues (100 mole %) and diol (and/or multifunctional hydroxyl compounds) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 30 mole % isophthalic acid, based on the total acid residues, means the polyester contains 30 mole % isophthalic acid residues out of a total of 100 mole % acid residues. Thus, there are 30 moles of isophthalic acid residues among every 100 moles of acid residues. In another example, a polyester containing 15 mole % 2,2,4,4-tetramethyl-1,3-cyclobutanediol, based on the total diol residues, means the polyester contains 15 mole % 2,2,4,4-tetramethyl-1,3-cyclobutanediol residues out of a total of 100 mole % diol residues. Thus, there are 15 moles of 2,2,4,4-tetramethyl-1,3-cyclobutanediol residues among every 100 moles of diol.

In certain embodiments, the dicarboxylic acid component comprises: 70 to 100 mole % of aromatic dicarboxylic acid residues having up to 20 carbon atoms; 0 to 30 mole % of one or more secondary aromatic dicarboxylic acid residues having up to 20 carbon atoms; and 0 to 30 mole % of one or more secondary aliphatic dicarboxylic acid residues having up to 16 carbon atoms; and the a glycol component comprising: 70 to 100 mole % of a glycol having up to 16 carbon atoms; 0 to 30 mole % of one or more secondary glycols having up to 16 carbon atoms; and the total mole % of the dicarboxylic acid component is 100 mole %, and the total mole % of the glycol component is 100 mole %;

In certain embodiments, the dicarboxylic acid component comprises residues of 1,4-cyclohexane dicarboxylic acid, 1,4-cyclohexane diacetic acid, naphthalene dicarboxylic acid, terephthalic acid, isophthalic acid, phthalic acid or mixtures thereof.

In other aspects of the invention, the glycol component for the polyesters useful in the invention include but are not limited to at least one of the following combinations of ranges: 1 to 15 mole % 2,2,4,4-tetramethyl-1,3-cyclobutanediol and 85 to 99 mole % 1,4-cyclohexanedimethanol; 1 to 14 mole % 2,2,4,4-tetramethyl-1,3-cyclobutanediol and 86 to 99 mole % 1,4-cyclohexanedimethanol; 1 to 13 mole % 2,2,4,4-tetramethyl-1,3-cyclobutanediol and 87 to 99 mole % 1,4-cyclohexanedimethanol; 1 to 12 mole % 2,2,4,4-tetramethyl-1,3-cyclobutanediol and 88 to 99 mole % 1,4-cyclohexanedimethanol; 1 to 11 mole % 2,2,4,4-tetramethyl-1,3-cyclobutanediol and 89 to 99 mole % 1,4-cyclohexanedimethanol; 1 to 10 mole % 2,2,4,4-tetramethyl-1,3-cyclobutanediol and 90 to 99 mole % 1,4-cyclohexanedimethanol; 1 to 9 mole % 2,2,4,4-tetramethyl-1,3-cyclobutanediol and 91 to 99 mole % 1,4-cyclohexanedimethanol; 1 to 8 mole % 2,2,4,4-tetramethyl-1,3-cyclobutanediol and 92 to 99 mole % 1,4-cyclohexanedimethanol; 1 to 7 mole % 2,2,4,4-tetramethyl-1,3-cyclobutanediol and 93 to 99 mole % 1,4-cyclohexanedimethanol; 1 to 6 mole % 2,2,4,4-tetramethyl-1,3-cyclobutanediol and 94 to 99 mole % 1,4-cyclohexanedimethanol; 1 to 5 mole % 2,2,4,4-tetramethyl-1,3-cyclobutanediol and 95 to 99 mole % 1,4-cyclohexanedimethanol; 1 to 4 mole % 2,2,4,4-tetramethyl-1,3-cyclobutanediol and 96 to 99 mole % 1,4-cyclohexanedimethanol; 1 to 3 mole % 2,2,4,4-tetramethyl-1,3-cyclobutanediol and 97 to 99 mole % 1,4-cyclohexanedimethanol; and 1 to 2 mole % 2,2,4,4-tetramethyl-1,3-cyclobutanediol and 98 to 99 mole % 1,4-cyclohexanedimethanol.

In other aspects of the invention, the glycol component for the polyesters useful in the film or sheet of the invention include but are not limited to at least one of the following combinations of ranges: 5 to 15 mole % 2,2,4,4-tetramethyl-1,3-cyclobutanediol and 85 to 95 mole % 1,4-cyclohexanedimethanol; and 5 to 10 mole % 2,2,4,4-tetramethyl-1,3-cyclobutanediol and 90 to 95 mole % 1,4-cyclohexanedimethanol.

In other aspects of the invention, the glycol component for the polyesters useful in the film or sheet of the invention include but are not limited to at least one of the following combinations of ranges: 85 to 99 mole % of 1,4-cyclohexanedimethanol residues and 1 to 15 mole % of one or more secondary glycols having up to 16 carbon atoms; 85 to 99 mole % of 1,4-cyclohexanedimethanol residues, and 1 to 15 mole % of 2,2,4,4-tetramethyl-1,3-cyclobutanediol residues; and 85 to 100 mole % of 1,4-cyclohexanedimethanol residues and 0 to 15 mole % of one or more secondary glycols having up to 16 carbon atoms.

In certain embodiments, the polyesters useful in the present invention, have a glass transition temperature (T_{g}) ranging from 55° C. to about 120° C. or from about 57° C. to about 110° C. or about 57° C. to about 85° C. In other embodiments of the invention, the T_{g} of the polyesters can be at least one of the following ranges: 55 to 120° C.; 57 to 110° C.; 57 to 85° C.; 60 to 120° C.; 60 to 115° C.; 60 to 110° C.; 60 to 105° C.; 60 to 100° C.; 60 to 75° C.; 60 to 85° C.; 60 to 95° C.; 75 to 85° C.; 75 to 95° C.; 75 to 100° C.; 75 to 105° C.; 75 to 110° C.; 75 to 120° C.; 85 to 95° C.; 85 to 110° C.; 85 to 105° C.; 85 to 120° C.; 95 to 110° C.; 95 to 120° C.; 100 to 115° C.; 100 to 110° C.; 100 to 105° C.; 105 to 115° C.; 105 to 110° C.; 110 to 115° C. and 110 to 120° C.

In certain embodiments, the polyester useful in the present invention have a melting temperature (Tₘ) ranging from about 220 to 265° C. or from about 225 to 255° C. In other aspects of the invention, the Tₘ of the polyesters useful in the invention can be at least one of the following ranges: 220 to 265° C.; 220 to 260° C.; 225 to 265° C.; 225 to 255° C.; 230 to 265° C.; 230 to 260° C.; 240 to 260° C.; 240 to 265° C.; 240 to 255° C.; 240 to 250° C.; 220 to 240C; 85 to 95° C.; 85 to 110° C.; 85 to 105° C.; 95 to 100° C.; 100 to 115° C.; 100 to 110° C.; 100 to 105° C.; 105 to 115° C.; 105 to 110° C.; 110 to 115° C. and 110 to 120° C.

For certain embodiments of the invention, the polyesters useful in the invention may exhibit at least one of the following inherent viscosities as determined in 60/40 (wt/wt) phenol/tetrachloroethane at a concentration of 0.5 g/100 ml at 25° C.: 0.35 to 1.2 dL/g; 0.35 to 1.1 dL/g; 0.35 to 1.0 dL/g; 0.35 to less than 1.0 dL/g; 0.35 to 0.98 dL/g; 0.35 to 0.95 dL/g; 0.35 to 0.90 dL/g; 0.35 to 0.85 dL/g; 0.35 to 0.80 dL/g; 0.35 to 0.75 dL/g; 0.35 to less than 0.75 dL/g; 0.35 to 0.72 dL/g; 0.35 to 0.70 dL/g; 0.35 to less than 0.70 dL/g; 0.35 to 0.68 dL/g; 0.35 to less than 0.68 dL/g; 0.35 to 0.65 dL/g; 0.40 to 1.2 dL/g; 0.40 to 1.1 dL/g; 0.40 to 1 dL/g; 0.40 to less than 1 dL/g; 0.40 to 0.98 dL/g; 0.40 to 0.95 dL/g; 0.40 to 0.90 dL/g; 0.40 to 0.85 dL/g; 0.40 to 0.80 dL/g; 0.40 to 0.75 dL/g; 0.40 to less than 0.75 dL/g; 0.40 to 0.72 dL/g; 0.40 to 0.70 dL/g; 0.40 to less than 0.70 dL/g; 0.40 to 0.68 dL/g; 0.40 to less than 0.68 dL/g; 0.40 to 0.65 dL/g; 0.45 to 1.2 dL/g; 0.45 to 1.1 dL/g; 0.45 to 1 dL/g; 0.45 to less than 1 dL/g; 0.45 to 0.98 dL/g; 0.45 to 0.95 dL/g; 0.45 to 0.90 dL/g; 0.45 to 0.85 dL/g; 0.45 to 0.80 dL/g; 0.45 to 0.75 dL/g; 0.45 to less than 0.75 dL/g; 0.45 to 0.72 dL/g; 0.45 to 0.70 dL/g; 0.45 to less than 0.70 dL/g; 0.45 to 0.68 dL/g; 0.45 to less than 0.68 dL/g; 0.45 to 0.65 dL/g; 0.50 to 1.2 dL/g; 0.50 to 1.1 dL/g; 0.50 to 1 dL/g; 0.50 to less than 1 dL/g; 0.50 to 0.98 dL/g; 0.50 to 0.95 dL/g; 0.50 to 0.90 dL/g; 0.50 to 0.85 dL/g; 0.50 to 0.80 dL/g; 0.50 to 0.75 dL/g; 0.50 to less than 0.75 dL/g; 0.50 to 0.72 dL/g; 0.50 to 0.70 dL/g; 0.50 to less than 0.70 dL/g; 0.50 to 0.68 dL/g; 0.50 to less than 0.68 dL/g; 0.50 to 0.65 dL/g; greater than 0.42 to 1.2 dL/g; greater than 0.42 to 1.1 dL/g; greater than 0.42 to 1 dL/g; greater than 0.42 to less than 1 dL/g; greater than 0.42 to 0.98 dL/g; greater than 0.42 to 0.95 dL/g; greater than 0.42 to 0.90 dL/g; greater than 0.42 to 0.85 dL/g; greater than 0.42 to 0.80 dL/g; greater than 0.42 to 0.75 dL/g; greater than 0.42 to less than 0.75 dL/g; greater than 0.42 to 0.72 dL/g; greater than 0.42 to less than 0.70 dL/g; greater than 0.42 to 0.68 dL/g; greater than 0.42 to less than 0.68 dL/g; and greater than 0.42 to 0.65 dL/g.

For certain embodiments of the invention, the polyesters useful in the invention may exhibit at least one of the following inherent viscosities as determined in 60/40 (wt/wt) phenol/tetrachloroethane at a concentration of 0.5 g/100 ml at 25° C.: 0.55 to 1.2 dL/g; 0.55 to 1.1 dL/g; 0.55 to 1 dL/g; 0.55 to less than 1 dL/g; 0.55 to 0.98 dL/g; 0.55 to 0.95 dL/g; 0.55 to 0.90 dL/g; 0.55 to 0.85 dL/g; 0.55 to 0.80 dL/g; 0.55 to 0.75 dL/g; 0.55 to less than 0.75 dL/g; 0.55 to 0.72 dL/g; 0.55 to 0.70 dL/g; 0.55 to less than 0.70 dL/g; 0.55 to 0.68 dL/g; 0.55 to less than 0.68 dL/g; 0.55 to 0.65 dL/g; 0.58 to 1.2 dL/g; 0.58 to 1.1 dL/g; 0.58 to 1 dL/g; 0.58 to less than 1 dL/g; 0.58 to 0.98 dL/g; 0.58 to 0.95 dL/g; 0.58 to 0.90 dL/g; 0.58 to 0.85 dL/g; 0.58 to 0.80 dL/g; 0.58 to 0.75 dL/g; 0.58 to less than 0.75 dL/g; 0.58 to 0.72 dL/g; 0.58 to 0.70 dL/g; 0.58 to less than 0.70 dL/g; 0.58 to 0.68 dL/g; 0.58 to less than 0.68 dL/g; 0.58 to 0.65 dL/g; 0.60 to 1.2 dL/g; 0.60 to 1.1 dL/g; 0.60 to 1 dL/g; 0.60 to less than 1 dL/g; 0.60 to 0.98 dL/g; 0.60 to 0.95 dL/g; 0.60 to 0.90 dL/g; 0.60 to 0.85 dL/g; 0.60 to 0.80 dL/g; 0.60 to 0.75 dL/g; 0.60 to less than 0.75 dL/g; 0.60 to 0.72 dL/g; 0.60 to 0.70 dL/g; 0.60 to less than 0.70 dL/g; 0.60 to 0.68 dL/g; 0.60 to less than 0.68 dL/g; 0.60 to 0.65 dL/g; 0.65 to 1.2 dL/g; 0.65 to 1.1 dL/g; 0.65 to 1 dL/g; 0.65 to less than 1 dL/g; 0.65 to 0.98 dL/g; 0.65 to 0.95 du/g; 0.65 to 0.90 dL/g; 0.65 to 0.85 du/g; 0.65 to 0.80 dL/g; 0.65 to 0.75 dL/g; 0.65 to less than 0.75 dL/g; 0.65 to 0.72 dL/g; 0.65 to 0.70 dL/g; or 0.65 to less than 0.70 dL/g; It is contemplated that the polyester compositions of the invention can possess at least one of the inherent viscosity ranges described herein and at least one of the monomer ranges for the compositions described herein unless otherwise stated.

It is also contemplated that the polyester compositions of the invention can have at least one of the T_{g} ranges described herein and at least one of the monomer ranges for the compositions described herein unless otherwise stated. It is also contemplated that the polyester compositions of the invention can have at least one of the T_{g} ranges described herein, at least one of the inherent viscosity ranges described herein, and at least one of the monomer ranges for the compositions described herein unless otherwise stated.

For the desired polyester, the molar ratio of cis/trans 2,2,4,4-tetramethyl-1,3-cyclobutanediol can vary from the pure form of each or mixtures thereof. In certain embodiments, the molar percentages for cis and/or trans 2,2,4,4-tetramethyl-1,3-cyclobutanediol are greater than 50 mole % cis and less than 50 mole % trans; or greater than 55 mole % cis and less than 45 mole % trans; or 30 to 70 mole % cis and 70 to 30% trans; or 40 to 60 mole % cis and 60 to 40 mole % trans; or 50 to 70 mole % trans and 50 to 30 mole % cis; or 50 to 70 mole % cis and 50 to 30% trans or 60 to 70 mole % cis and 30 to 40 mole % trans; or greater than 70 mole % cis and less than 30 mole % trans; wherein the total sum of the mole percentages for cis- and trans-2,2,4,4-tetramethyl-1,3-cyclobutanediol is equal to 100 mole %. The molar ratio of cis/trans 1,4-cyclohexandimethanol can vary within the range of 50/50 to 0/100, for example, between 40/60 to 20/80.

In certain embodiments, terephthalic acid, or an ester thereof, such as, for example, dimethyl terephthalate, or a mixture of terephthalic acid and an ester thereof, makes up most or all of the dicarboxylic acid component used to form the polyesters useful in the invention. In certain embodiments, terephthalic acid residues can make up a portion or all of the dicarboxylic acid component used to form the present polyester at a concentration of at least 70 mole %, such as at least 80 mole %, at least 90 mole %, at least 95 mole %, at least 99 mole %, or the preferred embodiment of 100 mole %. In certain embodiments, polyesters with higher amounts of terephthalic acid can be used in order to produce higher impact strength properties. For purposes of this disclosure, the terms “terephthalic acid” and “dimethyl terephthalate are used interchangeably herein. In one embodiment, dimethyl terephthalate is part or all of the dicarboxylic acid component used to make the polyesters useful in the present invention. In all embodiments, ranges of from 70 to 100 mole %; or 80 to 100 mole %; or 90 to 100 mole %; or 99 to 100 mole %; or 100 mole % terephthalic acid and/or dimethyl terephthalate and/or mixtures thereof may be used.

In addition to terephthalic acid residues, the dicarboxylic acid component of the polyesters useful in the invention can comprise up to 30 mole %, up to 20 mole %, up to 10 mole %, up to 5 mole %, or up to 1 mole % of one or more modifying aromatic dicarboxylic acids. The preferred embodiment contains 0 mole % modifying aromatic dicarboxylic acids. Thus, if present, it is contemplated that the amount of one or more modifying aromatic dicarboxylic acids can range from any of these preceding endpoint values including, for example, from 0.01 to 30 mole %, from 0.01 to 20 mole %, from 0.01 to 10 mole %, from 0.01 to 5 mole %, or from 0.01 to 1 mole % of one or more modifying aromatic dicarboxylic acids. In one embodiment, modifying aromatic dicarboxylic acids that may be used in the present invention include but are not limited to those having up to 20 carbon atoms, and that can be linear, para-oriented, or symmetrical. Examples of modifying aromatic dicarboxylic acids which may be used in this invention include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, isophthalic acid is the modifying aromatic dicarboxylic acid. The preferred embodiment of the invention is for 100% of the dicarboxylic acid component based on terephthalic acid residues.

The carboxylic acid component of the polyesters useful in the invention can be further modified with up to 10 mole %, such as up to 5 mole % or up to 1 mole % of one or more aliphatic dicarboxylic acids containing 2-16 carbon atoms, such as, for example, malonic, succinic, glutaric, adipic, pimelic, suberic, azelaic and dodecanedioic dicarboxylic acids. Certain embodiments can also comprise 0.01 or more mole %, such as 0.1 or more mole %, 1 or more mole %, 5 or more mole %, or 10 or more mole % of one or more modifying aliphatic dicarboxylic acids. The preferred embodiment contains 0 mole % modifying aliphatic dicarboxylic acids. Thus, if present, it is contemplated that the amount of one or more modifying aliphatic dicarboxylic acids can range from any of these preceding endpoint values including, for example, from 0.01 to 10 mole % and from 0.1 to 10 mole %. The total mole % of the dicarboxylic acid component is 100 mole %.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

The 1,4-cyclohexanedimethanol may be cis, trans, or a mixture thereof, for example, a cis/trans ratio of 60:40 to 40:60. In another embodiment, the trans-1,4-cyclohexanedimethanol can be present in the amount of 60 to 80 mole %.

The glycol component of the polyester portion of the polyester compositions useful in the invention can contain 14 mole % or less of one or more modifying glycols which are not 2,2,4,4-tetramethyl-1,3-cyclobutanediol or 1,4-cyclohexanedimethanol; in another embodiment, the polyesters useful in the invention can contain 10 mole % or less of one or more modifying glycols. In another embodiment, the polyesters useful in the invention can contain 5 mole % or less of one or more modifying glycols. In another embodiment, the polyesters useful in the invention can contain 3 mole % or less of one or more modifying glycols. In the preferred embodiment, the polyesters useful in the invention may contain 0 mole % modifying glycols. Certain embodiments can also contain 0.01 or more mole %, such as 0.1 or more mole %, 1 or more mole %, 5 or more mole %, or 10 or more mole % of one or more modifying glycols. Thus, if present, it is contemplated that the amount of one or more modifying glycols can range from any of these preceding endpoint values including, for example, from 0.1 to 10 mole %.

Modifying glycols useful in the polyesters useful in the invention refer to diols that may contain up to carbon atoms. Examples of suitable modifying glycols include, but are not limited to, of 2,2,4,4,-tetramethyl-1,3-cyclobutanediol, 1,4-cyclohexanedimethanol, isosorbide, neopentyl glycol, ethylene glycol, 1,3-propanediol, 1,4-butanediol, diethylene glycol, triethylene glycol or mixtures thereof. In one embodiment, the modifying glycol is ethylene glycol. In another embodiment, the modifying glycols include but are not limited to 1,3-propanediol and/or 1,4-butanediol. In another embodiment, ethylene glycol is excluded as a modifying diol. In another embodiment, 1,3-propanediol and 1,4-butanediol are excluded as modifying diols. The polyesters useful the invention can comprise from 0 to 10 mole percent, for example, from 0.01 to 5 mole percent, from 0.01 to 1 mole percent, from 0.05 to 5 mole percent, from 0.05 to 1 mole percent, or from 0.1 to 0.7 mole percent, or 0.1 to 0.5 mole percent, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester. The polyester(s) useful in the invention can thus be linear or branched. In certain embodiments, the branching monomer or agent may be added prior to and/or during and/or after the polymerization.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole percent of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

The polyesters useful in the invention can be made by processes known from the literature such as, for example, by processes in homogenous solution, by transesterification processes in the melt, and by two phase interfacial processes. Suitable methods include, but are not limited to, the steps of reacting one or more dicarboxylic acids with one or more glycols at a temperature of 100° C. to 315° C. at a pressure of 0.1 to 760 mm Hg for a time sufficient to form a polyester. See U.S. Pat. No. 3,772,405 for methods of producing polyesters, the disclosure regarding such methods is hereby incorporated herein by reference.

In another aspect, the invention relates to a process for producing a polyester. The process comprises: (I) heating a mixture comprising the monomers useful in any of the polyesters useful in the invention in the presence of a catalyst at a temperature of 150 to 240° C. for a time sufficient to produce an initial polyester; (II) heating the initial polyester of step (I) at a temperature of 240 to 320° C. for 1 to 4 hours; and (III) removing any unreacted glycols.

Suitable catalysts for use in this process include, but are not limited to, organo-zinc or tin compounds. The use of this type of catalyst is well known in the art. Examples of catalysts useful in the present invention include, but are not limited to, zinc acetate, butyltin tris-2-ethylhexanoate, dibutyltin diacetate, and/or dibutyltin oxide. Other catalysts may include, but are not limited to, those based on titanium, zinc, manganese, lithium, germanium, and cobalt. Catalyst amounts can range from 10 ppm to 20,000 ppm or 10 to 10,000 ppm, or to 5000 ppm or 10 to 1000 ppm or 10 to 500 ppm, or 10 to 300 ppm or 10 to 250 based on the catalyst metal and based on the weight of the final polymer. The process can be carried out in either a batch or continuous process.

Typically, step (I) can be carried out until 50% by weight or more of the 2,2,4,4-tetramethyl-1,3-cyclobutanediol has been reacted. Step (I) may be carried out under pressure, ranging from atmospheric pressure to 100 psig. The term “reaction product” as used in connection with any of the catalysts useful in the invention refers to any product of a polycondensation or esterification reaction with the catalyst and any of the monomers used in making the polyester as well as the product of a polycondensation or esterification reaction between the catalyst and any other type of additive.

Typically, Step (II) and Step (III) can be conducted at the same time. These steps can be carried out by methods known in the art such as by placing the reaction mixture under a pressure ranging from 0.002 psig to below atmospheric pressure, or by blowing hot nitrogen gas over the mixture.

The polyesters useful in this invention can also be prepared by reactive melt blending and extrusion of two polyesters. For example, the polyester can be blended with at least one polymer chosen from at least one of the following: poly(etherimides), polyesters, polyesters other than those of claim 1, polyphenylene oxides, poly(phenylene oxide)/polystyrene blends, polystyrene resins, polyphenylene sulfides, polyphenylene sulfide/sulfones, poly(ester-carbonates), polycarbonates, polysulfones; polysulfone ethers, and poly(ether-ketones).

The polyesters of this invention, prepared in a reactor or by melt blending/extrusion, can subsequently be crystallized if needed and solid stated by techniques known in the art to further increase the IV.

Strain induced crystallization refers to a phenomenon in which an initially amorphous solid material undergoes a phase transformation in which some amorphous domains are converted to crystalline domains due to the application of strain. This phenomenon has important effects in strength and fatigue properties. In one aspect of the invention, the articles of the invention have a strain induced crystallinity of greater than zero when stretched at a temperature above the T_{g} of the polyester.

In one embodiment of the invention, the article of the invention has a strain induced crystallinity of from 5% to 35% when stretched at a temperature above the T_{g} of the polyester.

In one embodiment of the invention, the article of the invention has a strain induced crystallinity of from 5% to 35% when stretched at temperatures from about 20° C. to about 50° C. above the T_{g} of the polyester.

In one embodiment of the invention, the article of the invention has a strain induced crystallinity of from 5% to 30% when stretched at a temperature above the T_{g} of the polyester.

In one embodiment of the invention, the article of the invention has a strain induced crystallinity of from 10% to 35% when stretched at a temperature above the T_{g} of the polyester.

In one embodiment of the invention, the article of the invention has a strain induced crystallinity of from 10% to 30% when stretched at a temperature above the T_{g} of the polyester.

In one embodiment of the invention, the article of the invention has a strain induced crystallinity of from 6% to 24% when stretched at a temperature above the T_{g} of the polyester.

In one embodiment of the invention, the article of the invention has a strain induced crystallinity of from 6% to 20% when stretched at a temperature above the T_{g} of the polyester.

In one embodiment of the invention, the article of the invention has a strain induced crystallinity of from 5% to 35% when stretched at a temperature 10° C. above the T_{g} of the polyester.

In one embodiment of the invention, the article of the invention has a strain induced crystallinity of from 5% to 35% when stretched at a temperature 20° C. above the T_{g} of the polyester.

In one embodiment of the invention, the article of the invention has a strain induced crystallinity of from 10% to 35% when stretched at a temperature 10° C. above the T_{g} of the polyester.

In one embodiment of the invention, the article of the invention has a strain induced crystallinity of from 10% to 35% when stretched at a temperature 20° C. above the T_{g} of the polyester.

In one embodiment of the invention, the article of the invention has a strain induced crystallinity of from 10% to 30% when stretched at a temperature 10° C. above the T_{g} of the polyester.

In one embodiment of the invention, the article of the invention has a strain induced crystallinity of from 10% to 30% when stretched at a temperature 20° C. above the T_{g} of the polyester.

In one embodiment of the invention, the article of the invention has a strain induced crystallinity of from 10% to 25% when stretched at a temperature 10° C. above the T_{g} of the polyester.

In one embodiment of the invention, the article of the invention has a strain induced crystallinity of from 10% to 25% when stretched at a temperature 20° C. above the T_{g} of the polyester.

In one embodiment of the invention, the article of the invention has a strain induced crystallinity of from 15% to 30% when stretched at a temperature 10° C. above the T_{g} of the polyester.

In one embodiment of the invention, the article of the invention has a strain induced crystallinity of from 15% to 30% when stretched at a temperature 20° C. above the T_{g} of the polyester.

In addition, the polyester useful in this invention may also contain from 0.01 to 25% by weight or 0.01 to 20% by weight or 0.01 to 15% by weight or 0.01 to 10% by weight or 0.01 to 5% by weight of the total weight of the polyester composition of common additives such as colorants, dyes, mold release agents, reheat additives, flame retardants, plasticizers, stabilizers, including but not limited to, UV stabilizers, thermal stabilizers and/or reaction products thereof, fillers, and impact modifiers. Examples of typical commercially available impact modifiers well known in the art and useful in this invention include, but are not limited to, ethylene/propylene terpolymers; functionalized polyolefins, such as those containing methyl acrylate and/or glycidyl methacrylate; styrene-based block copolymeric impact modifiers; and various acrylic core/shell type impact modifiers. For example, UV additives can be incorporated into articles of manufacture through addition to the bulk, through application of a hard coat, or through coextrusion of a cap layer. Residues of such additives are also contemplated as part of the polyester composition.

The polyesters useful in the invention can comprise at least one chain extender. Suitable chain extenders include, but are not limited to, multifunctional (including, but not limited to, bifunctional) isocyanates, multifunctional epoxides, including for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but is generally about 0.1 percent by weight to about 10 percent by weight, preferably about 0.1 to about 5 percent by weight, based on the total weight of the polyester.

Thermal stabilizers are compounds that stabilize polyesters during polyester manufacture and/or post polymerization including, but not limited to, phosphorous compounds including but not limited to phosphoric acid, phosphorous acid, phosphonic acid, phosphinic acid, phosphonous acid, and various esters and salts thereof. These can be present in the polyester compositions useful in the invention. The esters can be alkyl, branched alkyl, substituted alkyl, difunctional alkyl, alkyl ethers, aryl, and substituted aryl. In one embodiment, the number of ester groups present in the particular phosphorous compound can vary from zero up to the maximum allowable based on the number of hydroxyl groups present on the thermal stabilizer used. The term “thermal stabilizer” is intended to include the reaction products thereof. The term “reaction product” as used in connection with the thermal stabilizers of the invention refers to any product of a polycondensation or esterification reaction between the thermal stabilizer and any of the monomers used in making the polyester as well as the product of a polycondensation or esterification reaction between the catalyst and any other type of additive.

Reinforcing materials may be useful in the compositions of this invention. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials are glass, such as, fibrous glass filaments, mixtures of glass and talc, glass and mica, and glass and polymeric fibers.

The invention further relates to articles of manufacture. The articles include metal containers, metal packaging, metal cans, metal can lids, food and beverage containers, food and beverage cans.

The invention further relates to the film(s) and/or sheet(s) comprising the polyester compositions of the invention. The methods of forming the polyesters into film(s) and/or sheet(s) are well known in the art. Examples of film(s) and/or sheet(s) of the invention including but not limited to extruded film(s) and/or sheet(s), calendered film(s) and/or sheet(s), compression molded film(s) and/or sheet(s), solution casted film(s) and/or sheet(s). Methods of making film and/or sheet include but are not limited to extrusion, calendering, compression molding, and solution casting.

Examples of potential films and/or sheets include, but are not limited, biaxially stretched film, laminates, coated articles, laminated articles, and/or multilayered films or sheets.

The biaxially stretched films of the present invention can be suitably used to cover the inside surface of a two-piece metal can produced by drawing or ironing after laminating the film onto the metal substrate. It can also be used to cover the cover of a two-piece can or the body cover, bottom of a three-piece can because it adheres well to metal and is good in processability. It also can be used for can lids.

In one embodiment, the films further comprise toughening additives, pigments or dyes. In certain aspects of the invention the impact modifiers comprise MA modified SEBS, EPDM, GMA modified ethylene-acrylate copolymers, thermoplastic elastomers, modified polyolefins, and mixtures thereof.

The metal substrates in this present invention refers to various metal plates, surface-treated metal plates, tin, steel or aluminum plates, such as tin plate, ECCS, nickeled metal plate, galvanized metal plate, pure Aluminum plate or Aluminium alloy plate. Any metal substrate used in the can making industry is suitable for use in the present invention. The initial thickness of the metal plate may differ depending upon the kind of the metal used. Any thin metal substrate can be used in the present invention and any thickness suitable for use in the can making industry is suitable for use in the present invention. For example, the thickness of the metal substrate/plate can be 0.1 to 0.8 mm or it can be 0.1 to 0.5 mm.

The invention further relates to a method for producing the laminated articles. Pellets of one or more polyester resins are melted compounded at temperatures from about 250° C. to about 290° C., the melt compounded polyester(s) are then extruded using extruders at a temperature from 250° C. to about 290° C., the extruded films are then bi-axially stretched using different draw ratios in the machine direction and in the transverse direction (MD*TD), at a temperature above the T_{g} of the film, and at a nominal strain rate of 100%-300% per second. The metal substrate is heated to a temperature above the T_{g} of the film. The at least one layer of film is applied to at least one surface of the metal sheet at a pressure of 0.5-30 MPa and at a temperature of 210-270° C. The laminate is then heated so that the film is raised to a temperature above its T_{g} or close to its Tₘ, and at is held at such elevated temperature for 1-2 seconds. The laminate is then quenched rapidly using room temperature water to a temperature below the T_{g} of the polyester. For example, the quenching may occur in a water bath or by passing the film through a water curtain.

For example, in one aspect of the invention laminates are produced using conventional lamination processes. Typically, rolls of the metal substrate such as ECCS plate with a thickness of 0.15 mm and a width of 800 mm are unwound and conveyed to clean the surface in the pre-treatment unit, then the clean ECCS plate is conveyed to heating unit. The heating unit has an electronic heating roller designed to heat both sides of ECCS plate up to 210-270° C. at the speed of 50-130 m/min (0.8-2.2 m/sec), then the hot ECCS plate is conveyed into the lamination unit. Meanwhile rolls of the polyester film of present invention is conveyed to laminate on to both sides of hot ECCS plate by a roller or rubber roller with the pressure of 0.5-30 MPa, then after the films are laminated onto the ECCS plate is rapidly quenched using a water bath or water curtain of room temperature water for 1-2 seconds at a line speed of 50-130 m/min. After that, the surface water was removed from the laminate and laminate is conveyed to the package unit to make rolls of the laminate and then it is packaged.

One aspect of the invention provides laminates using this conventional process and the laminates are then cut and formed in articles including cylindrical containers and cans.

### EXAMPLES

The following examples are intended to be illustrative of the present invention in order to teach one of ordinary skill in the art to make and use the invention and are not intended to limit the scope of the invention in any way. As described below, several tests were performed on various polyester compositions, films, laminates and articles to evaluate the properties of both comparative and inventive materials.

### Example 1

### Preparation of Polyesters

Polyester compositions were prepared that contained various mole % of CHDM, TMCD, EG, CHDA, TPA and IPA which are showed in Table 1. In the following examples, CHDM is 1,4-Cyclohexanedimethanol, TMCD is 2,2,4,4-Tetramethyl-1,3-cyclobutanediol, EG is Ethylene glycol, CHDA is 1,4-Cyclohexane dicarboxylic acid, TPA is Terephthalic acid, IPA is Isophthalic acid. The inherent viscosity was measured for each composition and shown in Table 1.

The crystallinity for the polyester compositions at the temperature range of 130-180° C. is presented in Table 2.

### Analytical Analysis:

The polyester compositions of the present invention were characterized by using the following analytical techniques:
The inherent viscosity (IV) of the polyesters was determined in 60/40 (wt/wt) phenol/tetrachloroethane at a concentration of 0.5 g/100 ml at 25° C.
The composition of the neat resins was determined by proton nuclear magnetic resonance spectroscopy (NMR).
The melting point (Tₘ) and glass transition temperature (T_{g}) were measured by using TA instruments Q2000 model differential scanning calorimeter (DSC) at a scan rate of 20° C./min.
Thermal Analysis (DSC): Measured at a scan rate of 20° C./min. after the sample was heated above its melting temperature and rapidly quenched below its glass transition temperature
The amount of crystallinity was measured using DSC using the method of isothermal crystallization determined by TA instruments Q2000 model DSC.
   (1) The sample weight for these measurements was 4±1 mg.
   (2) The first heating scan was performed. The samples were heated from approximately 25° C. up to about 300° C. at the rate of 20° C./min. They were annealed for 10 minutes at 300° C. under a nitrogen atmosphere.
   (3) The samples were cooled to predetermined temperatures at a cooling rate of 100° C./min, and retained for 30 min at the pre-determined temperatures. The pre-determined temperatures were 130° C., 140° C., 150° C., 160° C., 170° C., and 180° C.
   (4) The samples were heated up from the predetermined temperature to 300° C. at the rate of 20° C./min, under a nitrogen atmosphere.

The absolute value of the area of the melting endotherms (one or more) minus the area of any crystallization exotherms was determined. This area corresponds to the net heat of melting and is expressed in J/g. The heat of melting of 100% crystalline PET is taken to be 121 J/g, so the weight fraction crystallinity of the pellet is calculated as the net heat of melting divided by 121. To obtain the weight % crystallinity, the weight fraction crystallinity is multiplied by 100.

TABLE 1
Polyester compositions and properties

| Example | | E1 | E2 | C1 | C2 | C3 |
|---|---|---|---|---|---|---|
| Polyester compositions | | | | | | |
| Diol | CHDM (mole %) | 100 | 87 | | 31 | 76 |
| | TMCD (mole %) | | 13 | | | 24 |
| | EG (mole %) | | | 100 | 69 | |
| Diacid or | CHDA (mole %) | 100 | | | | |
| ester | TPA (mole %) | | 97 | 100 | 100 | 100 |
| | IPA (mole %) | | 3 | | | |

| | | | | | |
|---|---|---|---|---|---|
| Properties | | | | | |
| IV(dl/g) | 0.87 | 0.79 | 0.58 | 0.72 | 0.72 |
| T_{g}(° C.) | 57 | 105 | 81 | 80 | 110 |
| Tₘ(° C.) | 225 | 265 | 252 | — | — |

TABLE 2
Amount of crystallinity in the polyester compositions

| | Amount of crystallinity/% | | | | |
|---|---|---|---|---|---|
| Temperature/° C. | E1 | E2 | C1 | C2 | C3 |
| 130 | 19.1 | 28.3 | 27.5 | 0 | 0 |
| 140 | 18.5 | 28.0 | 26.5 | 0 | 0 |
| 150 | 17.5 | 27.7 | 26.1 | 0 | 0 |
| 160 | 16.7 | 27.2 | 26.4 | 0 | 0 |
| 170 | 12.8 | 26.6 | 26.1 | 0 | 0 |
| 180 | 5.6 | 25.8 | 25.6 | 0 | 0 |
| Minimum amount of crystallinity | 5.6 | 25.8 | 25.6 | 0 | 0 |
| Maximum amount of | 19.1 | 28.3 | 27.5 | 0 | 0 |
| crystallinity | | | | | |

The data in Table 1 and Table 2 illustrate:
Certain CHDM and TMCD based polyesters in examples E1 and E2 have an amount of crystallinity ranging from 5.6% to 28.3% when measured at temperatures from 130-180° C. Examples E1 and E2 have a Tₘ of 225° C. and 265° C., respectively.

Example C1 has a crystallinity of greater than 25%; and Examples C2-C3 have a crystallinity of lower than 5%. C2 and C3 are the amorphous polymers without a Tₘ.

### Preparation of Laminates

### Experiment 1:

Polymer compositions E1, E2, C1, C2 and C3 were first made into films with 0.1-0.3 mm thickness using a pressure machine (Brand: Bolon precision; model: BL-6170-B) operating at 250-300° C. The films were thermo-compressed and formed in both sides of the molder. The molder has metal plates with a size of 300 mm*300 mm*0.3 mm which are coated with Teflon non-stick material. 2.5 gram polyester pellets were weighed using a balance (Brand: Mettler Toledo; Model: MS4002S; Precision: 0.01g), and were put in both sides of metal plate molding. Then the metal plate molding was thermo-compressed in the pressure machine operating at range of 250-300° C. with pressure of 6 MPa for 3 min. Next, the pressure was released to 0 MPa and the metal plate molding was pulled out quickly and cooled on both sides of the cool metal plate for 2 min at room temperature. After that, the polyester films were peeled off from the surface of the metal plate molding. The polyester films were prepared with thicknesses ranging from 0.1-0.3 mm. The polyester films were prepared as showed Table 3.

TABLE 3
Thermo-compression formed polyester films

| | Polyester composition | | | | |
|---|---|---|---|---|---|
| | E1 | E2 | C1 | C2 | C3 |
| IV (dl/g) | 0.87 | 0.79 | 0.58 | 0.72 | 0.72 |
| T_{g}/° C. | 57 | 105 | 81 | 80 | 110 |
| Tₘ/° C. | 226 | 265 | 252 | — | — |
| Weight/g | 2.5 | 2.5 | 2.5 | 2.5 | 2.5 |
| Thermo-compression | 250 | 300 | 300 | 250 | 250 |
| temperature/° C. | | | | | |
| Pressure/MPa | 6 | 6 | 6 | 6 | 6 |
| Heat time/min | 3 | 3 | 3 | 3 | 3 |
| Cool time/min | 2 | 2 | 2 | 2 | 2 |
| Thickness of thermo- | 0.1-0.3 | 0.1-0.3 | 0.1-0.3 | 0.1-0.3 | 0.1-0.3 |
| compression film/mm | | | | | |

### Experiment 2:

In experiment 2, the lamination of the metal plate with the films described above were prepared by thermo-compression manually using a Teflon coated rubber roller or using a pressure machine. First, with the manual process, the film was wrapped on the surface of the rubber roller, and meanwhile the tin plate was heated up to near the Tₘ of the polymer film. Then, the film was laminated onto metal plate manually by thermo-compression using the rubber roller with a pressure of 0.5 MPa for about 10 seconds. Also, the polyester films were laminated onto a metal plate using both sides of the molder. The molder had metal plates with a size of 300 mm*300 mm*3 mm which are coated with Teflon non-stick material. The film laminates were prepared by thermo-compressing in the pressure machine operating at a range of 220-280° C. with pressure of 6 MPa for 1 min. The pressure was then released to 0 MPa and the metal molding was pulled out quickly and cooled for 2 min at room temperature. Next, the metal plate was cooled quickly in water bath with room temperature water. Next, the laminated metal plate was pulled away from the surface of the molding. All the polymer films on the surface of metal plate were visually clear. The laminates were prepared as showed Table 4.

TABLE 4
Laminates

| | Polyester composition | | | | | | | | | |
|---|---|---|---|---|---|---|---|---|---|---|
| | E1 | | E2 | | C1 | | C2 | | C3 | |
| | Laminate | | | | | | | | | |
| | E11 | E12 | E21 | E22 | C11 | C12 | C21 | C22 | C31 | C32 |
| Metal plate | ECCS | Tin plate | ECCS | Tin plate | ECCS | Tin plate | ECCS | Tin plate | ECCS | Tin plate |
| Surface treatment | chrome | Tin | chrome | Tin | chrome | Tin | chrome | Tin | chrome | Tin |
| Metal melt point of surface | 1860 | 232 | 1860 | 232 | 1860 | 232 | 1860 | 232 | 1860 | 232 |
| treatment/° C. | | | | | | | | | | |
| Polyester melt point/° C. | 225 | 225 | 265 | 265 | 252 | 252 | — | — | — | — |
| Temperature of thermo- | 220 | 220 | 260 | NA | 280 | NA | 220 | 220 | 220 | 220 |
| compression/° C. | | | | | | | | | | |
| Pressure/MPa | 6 | 6 | 6 | | 6 | | 6 | 6 | 6 | 6 |
| Retention time/min | 1 | 1 | 1 | | 1 | | 1 | 1 | 1 | 1 |
| Cool time/min | 2 | 2 | 2 | | 2 | | 2 | 2 | 2 | 2 |
| Metal plate thickness/mm | 0.15 | 0.25 | 0.15 | | 0.15 | | 0.15 | 0.25 | 0.15 | 0.25 |
| Film + Metal thickness/mm | 0.22-0.32 | 0.32-0.39 | 0.23-0.35 | | 0.24-0.33 | | 0.19-0.29 | 0.29-0.42 | 0.19-0.39 | 0.29-0.47 |
| Laminated film thickness/mm | 0.07-0.17 | 0.07-0.14 | 0.08-0.20 | | 0.09-0.18 | | 0.04-0.14 | 0.04-0.17 | 0.04-0.14 | 0.04-0.22 |

NA = Not Applicable

As shown in table 4, examples E2 and C1 have melting points of 265° C. and 288° C., respectively. These temperatures exceed the melting point of Tin, so E2 and C1 were not suitable to laminate with Tin plate, but they were suitable for ECCS plate (which is surface-treated with chrome with the melting point of 1860° C.).

### Experiment 3: Step-1 Evaluation

The laminates prepared in experiment 2 were tested to evaluate retort resistance using a steam retort resistance test. For the steam retort test, the laminated metal plates were dented to 20 mm with depth of 5 mm, and then put into the steaming conditions of 121° C. for 30 min. After the retort testing the appearance of the laminates were evaluated using the following assessment criteria. The following criteria were used to assess the appearance of the laminates:

◯: Indicates that there was almost no whitening or peeling.

Δ: Indicates that there was slight or inconsistent whitening or slight peeling.

×: Indicates that there was significant whitening or significant peeling.

TABLE 5
Retort test in step-1

| | Polyester Composition | | | | | | | |
|---|---|---|---|---|---|---|---|---|
| | E1 | | E2 | C1 | C2 | | C3 | |
| | Films | | | | | | | |
| | E11 | E12 | E21 | C11 | C21 | C22 | C31 | C32 |
| Metal plate | ECCS | Tin plate | ECCS | ECCS | ECCS | Tin plate | ECCS | Tin plate |
| Retort temperature/° C. | 121 | 121 | 121 | 121 | 121 | 121 | 121 | 121 |
| Steaming retort time/min | 30 | 30 | 30 | 30 | 30 | 30 | 30 | 30 |
| Whitening or not | ◯ | ◯ | ◯ | X | X | X | X | X |
| Peeling or not | ◯ | ◯ | ◯ | X | X | X | X | X |

As indicated in table 5 of retort test in step-1, the polymer films on the surface of ECCS and Tin plate do not show whitening or peeling in the examples E1 and E2. However, there is significant whitening and peeling in examples C1-C3.

### Preparation of Extruded Films

### Experiment 4:

Experiment 4 illustrates that polyester compositions containing certain CHDM and TMCD ratios can be extruded as films and subsequently stretched at temperatures above the T_{g} of the polyesters to create semi-crystalline films.

Polyester compositions E1 and E2 were prepared by melt compounding polyesters at different weight ratios at 290° C. on a Sterling 1.5 inch pelletizing single screw extruder. The polyesters were produced commercially by Eastman Chemical Company.

Polyester compositions E1 and E2 were extruded into clear amorphous sheets using a Killian 1 inch single screw extruder operating at 250° C. for E1 and at 290° C. for E2. The sheets were then cut into 4.5″ squares for stretching in a Bruckner KARO IV Laboratory stretching machine. The grip distance was 110 mm. Films of all the materials were bi-axially stretched to different draw ratios (MD*TD) at different temperatures relative to T_{g} (T_{g}+20 to T_{g}+45° C.) and a nominal strain rate of 300% per second. All of the polyester films were visually clear after stretching.

Film E13 is polyester compositions E1 extruded into a 0.25 mm sheet and stretched into a 0.03 mm film. Films E23, E24 and E25 are polyester composition E2 extruded into 0.51 mm sheets and stretched into 0.03 mm films. C13, C23, C33 are polyester compositions C1, C2 and C3 that are designed to enable casting or stretching of film. The polyester films were prepared as showed in table 6

TABLE 6
polyester films

| | Polyester Compositions | | | | | | |
|---|---|---|---|---|---|---|---|
| | E1 | E2 | | | C1 | C2 | C3 |
| | Films | | | | | | |
| | E13 | E23 | E24 | E25 | C13 | C23 | C33 |
| T_{g}(° C.) | 57 | 105 | 105 | 105 | 81 | 80 | 110 |
| Tₘ(° C.) | 225 | 265 | 265 | 265 | 252 | — | — |
| Casting film or not | — | — | — | — | — | — | casting |
| Stretch temperature(° C.) | T_{g} + 20 | T_{g} + 35 | T_{g} + 40 | T_{g} + 45 | T_{g} + 30 | T_{g} + 30 | — |
| Stretch ratio(MD*TD) | 3*3 | 4*4 | 4*4 | 4*4 | 4*4 | 4*4 | — |
| Film thickness(mm) | 0.03 | 0.03 | 0.03 | 0.03 | 0.2 | 0.06 | 0.2 |

### Experiment 5

Experiment 5 was designed to simulate a manufacturing lamination process. During manufacturing, the lamination process run at a speed of about 100-130 m/min (1.7-2.2 m/sec) where the retention time of heat laminating is around 1-2 seconds, then it was cooled in water bath quickly. The fast speeds during manufacturing do not typically impact the film crystallinity. However, samples made manually in the lab may be influenced by the slower retention times of 10 seconds. Typically, the amount of crystallinity of films made manually in lab is about 1-7% lower than the crystallinity of films made in a manufacturing production process.

In experiment 5, polyester films of the present invention were laminated onto metal plates by manually thermo-compressing using a rubber roller coated with non-stick materials. First, the polyester film was wrapped around the surface of rubber roller, and the tin plate was heated up to a temperature near the Tₘ of the polymer film. Next, the film was laminated onto metal plate by manually thermo-compressing it using the rubber roller with pressure of 0.5 MPa for about 10 seconds. Lastly, the metal plate was cooled quickly in a room temperature water bath. During this experiment, all the polymer films laminated onto the surfaces of metal plates were visually clear. The laminates were prepared as showed in Table 7.

TABLE 7
polyester films laminated onto metal plates

| | Polyester Compositions | | | | | | |
|---|---|---|---|---|---|---|---|
| | E1 | E2 | | | C1 | C2 | C3 |
| | Films | | | | | | |
| | E13 | E23 | E24 | E25 | C13 | C23 | C33 |
| Metal plates | Tin plate | ECCS | ECCS | ECCS | ECCS | Tin plate | Tin plate |
| Surface treatment of metal plates | Tin | chrome | chrome | chrome | chrome | Tin | Tin |
| Metal melt point of surface | 232 | 1860 | 1860 | 1860 | 1860 | 232 | 232 |
| treatment(° C.) | | | | | | | |
| Film melt point(° C.) | 225 | 265 | 265 | 265 | 252 | — | — |
| Temperature of thermo- | 220 | 260 | 260 | 260 | 250 | 220 | 220 |
| compression(° C.) | | | | | | | |
| Pressure (MPa) | 0.5 | 0.5 | 0.5 | 0.5 | 0.5 | 0.5 | 0.5 |
| Retention time (sec) | 10 | 10 | 10 | 10 | 10 | 10 | 10 |
| Metal plate thickness(mm) | 0.25 | 0.15 | 0.15 | 0.15 | 0.15 | 0.25 | 0.25 |
| Film thickness(mm) | 0.03 | 0.03 | 0.03 | 0.03 | 0.2 | 0.06 | 0.2 |
| Film + metal plate thickness(mm) | 0.28 | 0.18 | 0.18 | 0.18 | 0.35 | 0.31 | 0.45 |

TABLE 8
Amount of crystallinity in the laminated films

| | Polyester compositions | | | | | | |
|---|---|---|---|---|---|---|---|
| | E1 | E2 | | | C1 | C2 | C3 |
| | Films | | | | | | |
| | E13 | E23 | E24 | E25 | C13 | C23 | C33 |
| Metal plates | Tin plate | ECCS | ECCS | ECCS | ECCS | Tin plate | Tin plate |
| Surface treatment of metal plates | Tin | chrome | chrome | chrome | chrome | Tin | Tin |
| T_{g} (° C.) | 57 | 105 | 105 | 105 | 81 | 80 | 110 |
| Tₘ (° C.) | 225 | 265 | 265 | 265 | 252 | — | — |
| Film thickness (mm) | 0.03 | 0.03 | 0.03 | 0.03 | 0.2 | 0.06 | 0.2 |
| Crystallinity (%) | 13.6 | 23.4 | 21.3 | 6.6 | 34.6 | 0 | 0 |

In Table 8, the crystallinity (%) of the laminates was determined by equation (1) from the first heating scan of films evaluated in a DSC.

Cystallinity(%)=(Hₘ₁−H_{ch1})121×100 (10

As indicated in Table 8,
The laminate from polyester )composition E1 has a crystallinity of 13.6%.
The laminates from polyester compositions E2 (Films E23, E24, and E25) have crystallinity ranging from 6.6% to 23.4%.
The laminate from C1 has a crystallinity of 34.6% and the laminates from C2 and C3 have crystallinity of lower than 5% (Examples C2 and C3 are amorphous polymers).
   Experiment 6: Step-2 evaluation

The laminates prepared in experiment 5 were tested to evaluate their retort resistance. The laminates were dented to 20 mm with depth of 5 mm, and then placed in the steaming conditions of 121° C. for 30 min. The following criteria was used to assess the appearance of the laminates:

◯: Indicates that there was almost no whitening or peeling.

Δ: Indicates that there was slight or inconsistent whitening or slight peeling.

×: Indicates that there was significant whitening or significant peeling.

TABLE 9
Retort test

| | Polyester Compositions | | | | | | |
|---|---|---|---|---|---|---|---|
| | E1 | E2 | | | C1 | C2 | C3 |
| | Films | | | | | | |
| | E13 | E23 | E24 | E25 | C13 | C23 | C33 |
| Metal plates | Tin plate | ECCS | ECCS | ECCS | ECCS | Tin plate | Tin plate |
| Surface treatment of metal plates | Tin | chrome | chrome | chrome | chrome | Tin | Tin |
| Retort temperatures(° C.) | 121 | 121 | 121 | 121 | 121 | 121 | 121 |
| Retort times(min) | 30 | 30 | 30 | 30 | 30 | 30 | 30 |
| Whitening or not | ◯ | ◯ | ◯ | ◯ | X | X | X |
| Peeling or not | ◯ | ◯ | ◯ | ◯ | X | X | X |

As indicated in table 9, the laminate made from polymer composition E1 has excellent retort resistance when laminated onto a Tin plate. Also, the polymer composition E2 was extruded and stretched into thin films of E23, E24 and E25 at different stretching conditions. These laminates show the excellent performance in retort resistance when it was laminated onto the surface of ECCS metal plates. However, there was significant whitening or peeling in examples C1-C3.

As the Examples above show, polyester in the present invention provide good adhesion, and retort resistance making them useful a film for can lamination.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, or characteristics given for any single component of the present disclosure can be used interchangeably with any ranges, values or characteristics given for any of the other components of the disclosure, where compatible, to form an embodiment having defined values for each of the components, as given herein throughout.

What is claimed is:

1. An article comprising a clear, semicrystalline, strain induced crystallized polyester film heat laminated onto a metal substrate, wherein the film comprises at least one polyester which comprises:
(A) a dicarboxylic acid component comprising either:
i) 70 to 100 mole % of aromatic dicarboxylic acid residues having up to 20 carbon atoms;
ii) 0 to 30 mole % of one or more secondary aromatic dicarboxylic acid residues having up to 20 carbon atoms; and
iii) 0 to 30 mole % of one or more secondary aliphatic dicarboxylic acid residues having up to 16 carbon atoms; or
i) 0 to 30 mole % of one or more aromatic dicarboxylic acid residues having up to 20 carbon atoms;
ii) 70 to 100 mole % of one or more secondary aliphatic dicarboxylic acid residues having up to 16 carbon atoms; and
(B) a glycol component comprising:
i) 70 to 100 mole % of a glycol having up to 16 carbon atoms
ii) 0 to 30 mole % of one or more secondary glycols having up to 16 carbon atoms; and
wherein the total mole % of the dicarboxylic acid component is 100 mole %, and the total mole % of the glycol component is 100 mole %;
wherein the inherent viscosity of the polyester is 0.35 to 1.2 dL/g as determined in 60/40 (wt/wt) phenol/tetrachloroethane at a concentration of 0.5 g/100 ml at 25° C.;
wherein said polyester has a T_{g} of 55 to 120° C.; and
wherein said film has a strain induced strain induced crystallinity of 5 to 30% when stretched at a temperature above the T_{g} of the polyester.

2. The polyester according to claim 1, wherein the glycol component comprises:
i) 85 to 99 mole % of 1,4-cyclohexanedimethanol residues, and
ii) 1 to 15 mole % of one or more secondary glycols having up to 16 carbon atoms; and
wherein the total mole % of the dicarboxylic acid component is 100 mole %, and the total mole % of the glycol component is 100 mole %.

3. The polyester according to claim 1, wherein the glycol component comprises:
i) 85 to 99 mole % of 1,4-cyclohexanedimethanol residues, and
ii) 1 to 15 mole % of 2,2,4,4-tetramethyl-1,3-cyclobutanediol residues; and
wherein the total mole % of the dicarboxylic acid component is 100 mole %, and the total mole % of the glycol component is 100 mole.

4. The polyester according to claim 1, wherein the glycol component comprises:
i) 85 to 100 mole % of 1,4-cyclohexanedimethanol residues, and
ii) 0 to 15 mole % of one or more secondary glycols having up to 16 carbon atoms; and
wherein the total mole % of the dicarboxylic acid component is 100 mole %, and the total mole % of the glycol component is 100 mole %.

5. The polyester of claim 1, wherein the dicarboxylic acid component comprises residues of 1,4-cyclohexane dicarboxylic acid, 1,4-cyclohexane diacetic acid, naphthalene dicarboxylic acid, terephthalic acid, isophthalic acid, phthalic acid or mixtures thereof.

6. The polyester of claim 1, wherein the glycol component comprises residues of 2,2,4,4,-tetramethyl-1,3-cyclobutanediol, 1,4-cyclohexanedimethanol, isosorbide, neopentyl glycol, ethylene glycol, 1,3-propanediol, 1,4-butanediol, diethylene glycol, triethylene glycol, polytetramethylene glycol, polyether glycol or mixtures thereof.

7. The film of claim 1, wherein said polyester is blended with at least one polymer chosen from at least one of the following: poly(etherimides), polyesters, polyesters other than those of claim 1, polyphenylene oxides, poly(phenylene oxide)/polystyrene blends, polystyrene resins, polyphenylene sulfides, polyphenylene sulfide/sulfones, poly(ester-carbonates), polycarbonates, polysulfones; polysulfone ethers, and poly(ether-ketones).

8. The film of claim 1, wherein the inherent viscosity of the polyester is from 0.60 to 1.2 dL/g.

9. The film of claim 1, wherein the inherent viscosity of the polyester is from 0.60 to 1.0 dL/g.

10. The film of claim 1, wherein the polyester has a T_{g} of 57 to 110° C.

11. The film of claim 1, wherein the polyester has a T_{g} of 57 to 85° C.

12. The film of claim 1, wherein the polyester has a Tₘ of 220 to 265° C.

13. The film of claim 1, wherein the polyester has a Tₘ of 225 to 255° C.

14. The film of claim 1, wherein the polyester has a strain induced crystallinity when stretched at temperatures from about 20° C. to about 50° C. above the T_{g} of the polyester.

15. The film of claim 1, wherein the polyester has a strain induced crystallinity from 10% to 30% when stretched at temperature above the T_{g} of the polyester.

16. The film of claim 1, wherein the polyester has a strain induced crystallinity from 6% to 24% when stretched at temperature above the T_{g} of the polyester.

17. The film of claim 1, wherein said polyester further comprises residues of at least one branching agent.

18. The film of claim 13, wherein said branching agent is in an amount from 0.01 to 10 weight % based on the total mole percentage of the dicarboxylic acid and the glycol component.

19. The film of claim 1, wherein the thickness of the film is 1 to 200 um.

20. The film of claim 1, wherein the thickness of the film is 5 to 50 um.

21. The article of claim 1, wherein the thickness of the metal is 100 to 400 um.

22. The article of claim 1, wherein the thickness of the metal is 250 to 350 um.

23. The article of claim 1, wherein the metal is aluminum, tin, steel, tin plate, tin plate steel, tin-free plate, surface-treated steel plate, aluminum plate, electrolytic chrome-coated steel plate, nickeled steel plate, galvanized steel plate, aluminum plate, or aluminum alloy plate.

24. The article of claim 1, wherein the film is a single layer.

25. The article of claim 1, wherein the film is a multilayered.

26. The article of claim 25, wherein the second layer of the multilayered film comprises polyesters, polyesters other than those of the first layer, PET(G), PBT, PP and mixtures thereof and a strain induced strain induced crystallinity higher than the first layer.

27. The article of claim 1, wherein the film is laminated on to both sides of the metal substrate.

28. A can, a drawn can, a drawn-redrawn can or a can lid according to claim 1.

29. A food or beverage container according to claim 1.

30. The polyester of claim 1, wherein the film further comprises impact, modifiers, toughening additives, pigments or dyes.

31. The polyester of claim 30, wherein the impact modifiers comprise MA modified SEBS, EPDM, GMA modified ethylene-acrylate copolymers, thermoplastic elastomers, modified polyolefins, and mixtures thereof.

32. An article comprising a multilayered clear, semicrystalline, strain induced crystallized strain induced crystallized polyester film heat laminated onto a metal substrate, wherein the first layer of the film comprises at least one polyester which comprises:
(a) a dicarboxylic acid component comprising:
i) 70 to 100 mole % of aromatic dicarboxylic acid residues having up to 20 carbon atoms;
ii) 0 to 30 mole % of one or more secondary aromatic dicarboxylic acid residues having up to 20 carbon atoms; and
iii) 0 to 30 mole % of one or more secondary aliphatic dicarboxylic acid residues having up to 16 carbon atoms; and
(b) a glycol component comprising:
i) 70 to 100 mole % of a glycol having up to 16 carbon atoms
ii) 0 to 30 mole % of one or more secondary glycols having up to 16 carbon atoms; and
wherein the total mole % of the dicarboxylic acid component is 100 mole %, and the total mole % of the glycol component is 100 mole %;
wherein the inherent viscosity of the polyester is 0.35 to 1.2 dL/g as determined in 60/40 (wt/wt) phenol/tetrachloroethane at a concentration of 0.5 g/100 ml at 25° C.;
wherein said polyester has a T_{g} of 55 to 120° C.; and
wherein said film has a strain induced strain induced crystallinity of 1 to 30% when stretched at a temperature above the T_{g} of the polyester when stretched at temperature above the T_{g} of the polyester; and wherein the second layer comprises the polyesters of the first layer or but the strain induced crystallinity is higher than the first layer and optionally wherein the third layer comprises the polyesters of the first and second layer but the strain induced crystallinity is higher than the first and second layers.

33. The multilayer films of claim 32, wherein the second layer further comprises polyesters, polyesters other than those of the first layer, PET(G), PBT, PP and mixtures thereof and the optional third layer further comprises polyesters, polyesters other than those of the first layer, PET, PBT, PP, PEN, PCT and mixtures thereof.

34. A process for making a laminate of a metal substrate and a semicrystalline, strain induced crystallized polyester, comprising the steps of:
1) melt compounding one or more polyester(s) at a temperature of about 250° C. to about 290° C., wherein at least one polyester which comprises:
(A) a dicarboxylic acid component comprising either:
i) 70 to 100 mole % of aromatic dicarboxylic acid residues having up to 20 carbon atoms;
ii) 0 to 30 mole % of one or more secondary aromatic dicarboxylic acid residues having up to 20 carbon atoms; and
iii) 0 to 30 mole % of one or more secondary aliphatic dicarboxylic acid residues having up to 16 carbon atoms; or
i) 0 to 30 mole % of one or more aromatic dicarboxylic acid residues having up to 20 carbon atoms;
ii) 70 to 100 mole % of one or more secondary aliphatic dicarboxylic acid residues having up to 16 carbon atoms; and
(B) a glycol component comprising:
i) 70 to 100 mole % of a glycol having up to 16 carbon atoms
ii) 0 to 30 mole % of one or more secondary glycols having up to 16 carbon atoms; and
wherein the total mole % of the dicarboxylic acid component is 100 mole %, and the total mole % of the glycol component is 100 mole %;
wherein the inherent viscosity of the polyester is 0.35 to 1.2 dL/g as determined in 60/40 (wt/wt) phenol/tetrachloroethane at a concentration of 0.5 g/100 ml at 25° C.; and
wherein said polyester has a T_{g} of 55 to 120° C.;
2) extruding the melt compounded polyester(s) at a temperature of about 250° C. to about 290° C.,
3) bi-axially stretching the extruded films to different draw ratios (MD*TD), at a temperature above the T_{g} of the film, and at a strain rate of 100% to 300% per second,
4) heating the metal substrate to a temperature above the T_{g} of the film,
5) applying the film to a least one surface of the metal substrate under a pressure of 0.5-30 MPa and at a temperature of 210 to 270° C.,
6) heating the laminate to raise the film temperature above its T_{g} or close to its Tₘ, and holding at such elevated temperature,
7) quenching rapidly the heated laminate to a temperature below the T_{g} of the polyester,
8) providing a laminate comprising a metal substrate and a film layer of biaxially-oriented polyester having a semi-crystalline structure.

35. The polyester according to claim 34, wherein the glycol component comprises:
i) 85 to 99 mole % of 1,4-cyclohexanedimethanol residues, and
ii) 1 to 15 mole % of one or more secondary glycols having up to 16 carbon atoms; and
wherein the total mole % of the dicarboxylic acid component is 100 mole %, and the total mole % of the glycol component is 100 mole %.

36. The polyester according to claim 34, wherein the glycol component comprises:
i) 85 to 99 mole % of 1,4-cyclohexanedimethanol residues, and
ii) 1 to 15 mole % of 2,2,4,4-tetramethyl-1,3-cyclobutanediol residues; and
wherein the total mole % of the dicarboxylic acid component is 100 mole %, and the total mole % of the glycol component is 100 mole.

37. The polyester according to claim 34, wherein the glycol component comprises:
i) 85 to 100 mole % of 1,4-cyclohexanedimethanol residues, and
ii) 0 to 15 mole % of one or more secondary glycols having up to 16 carbon atoms; and
wherein the total mole % of the dicarboxylic acid component is 100 mole %, and the total mole % of the glycol component is 100 mole %.

38. The polyester of claim 34, wherein the dicarboxylic acid component comprises residues of 1,4-cyclohexane dicarboxylic acid, 1,4-cyclohexane diacetic acid, naphthalene dicarboxylic acid, terephthalic acid, isophthalic acid, phthalic acid or mixtures thereof.

39. The polyester of claim 34, wherein the glycol component comprises residues of 2,2,4,4,-tetramethyl-1,3-cyclobutanediol, 1,4-cyclohexanedimethanol, isosorbide, neopentyl glycol, ethylene glycol, 1,3-propanediol, 1,4-butanediol, diethylene glycol, triethylene glycol, polytetramethylene glycol, polyether glycol or mixtures thereof.

40. The polyester of claim 34, wherein said polyester is blended with at least one polymer chosen from at least one of the following: poly(etherimides), polyesters, polyesters other than those of claim 1, polyphenylene oxides, poly(phenylene oxide)/polystyrene blends, polystyrene resins, polyphenylene sulfides, polyphenylene sulfide/sulfones, poly(ester-carbonates), polycarbonates, polysulfones; polysulfone ethers, and poly(ether-ketones).

41. The process of claim 34, wherein the inherent viscosity of the polyester is from 0.60 to 1.2 dL/g.

42. The process of claim 34, wherein the polyester has a T_{g} of 57 to 110° C.

43. The process of claim 34, wherein the polyester has a T_{g} of 57 to 85° C.

44. The process of claim 34, wherein the polyester has a Tₘ of 220 to 265° C.

45. The process of claim 34, wherein the polyester has a Tₘ of 225 to 255° C.

46. The process of claim 34, wherein the polyester has a strain induced crystallinity when stretched at temperatures from about 20° C. to about 50° C. above the T_{g} of the polyester.

47. The process of claim 34, wherein the polyester has a strain induced crystallinity from 5% to 30% when stretched at temperature above the T_{g} of the polyester.

48. The process of claim 34, wherein the polyester has a strain induced crystallinity from 5% to 25% when stretched at temperature above the T_{g} of the polyester.

49. The process of claim 34, wherein said polyester further comprises residues of at least one branching agent.

50. The process of claim 49, wherein said branching agent is in an amount from 0.01 to 10 weight % based on the total mole percentage of the dicarboxylic acid and the glycol component.

51. The process of claim 34, wherein the thickness of the extruded film is about 1 to about 200 um.

52. The process of claim 34, wherein the thickness of the extruded film is about 5 to about 50 um.

53. The process of claim 34, wherein the thickness of the metal substrate is about 100 to about 400 um.

54. The process of claim 34, wherein the thickness of the metal substrate is about 250 to about 350 um.

55. The process of claim 34, wherein the metal substrate is aluminum, tin, steel, tin plate, tin plate steel, tin-free plate, surface-treated steel plate, aluminum plate, electrolytic chrome-coated steel plate, nickeled steel plate, galvanized steel plate, aluminum plate, or aluminum alloy plate.

56. The process of claim 34, wherein the film is a single layer.

57. The process of claim 34, wherein the film is multilayered

58. The process of claim 34, wherein the laminate is cut and formed into a cylindrical article.

59. A metal can according to the process of claim 58.

60. A drawn metal or a drawn-redrawn metal can according to the process of claim 58.

61. A metal can lid according to the process of claim 58.

62. The process of claim 34, wherein the draw ratio is MD (2X-5X)*TD (2X-5X).

63. A metal can comprising a clear, semicrystalline, strain induced crystallized polyester film heat laminated onto a metal substrate, wherein the film comprises at least one polyester which comprises:
(A) a dicarboxylic acid component comprising either:
i) 70 to 100 mole % of aromatic dicarboxylic acid residues having up to 20 carbon atoms;
ii) 0 to 30 mole % of one or more secondary aromatic dicarboxylic acid residues having up to 20 carbon atoms; and
iii) 0 to 30 mole % of one or more secondary aliphatic dicarboxylic acid residues having up to 16 carbon atoms; or
i) 0 to 30 mole % of one or more aromatic dicarboxylic acid residues having up to 20 carbon atoms;
ii) 70 to 100 mole % of one or more secondary aliphatic dicarboxylic acid residues having up to 16 carbon atoms; and
(B) a glycol component comprising:
i) 70 to 100 mole % of a glycol having up to 16 carbon atoms
ii) 0 to 30 mole % of one or more secondary glycols having up to 16 carbon atoms; and
wherein the total mole % of the dicarboxylic acid component is 100 mole %, and the total mole % of the glycol component is 100 mole %;
wherein the inherent viscosity of the polyester is 0.35 to 1.2 dL/g as determined in 60/40 (wt/wt) phenol/tetrachloroethane at a concentration of 0.5 g/100 ml at 25° C.;
wherein the thickness of the film is about 1 to about 200 um;
wherein the thickness of the metal substrate is about 100 to about 400 um and wherein the metal substrate comprises aluminum, tin, steel, tin plate, tin plate steel, tin-free plate, surface-treated steel plate, aluminum plate, electrolytic chrome-coated steel plate, nickeled steel plate, galvanized steel plate, aluminum plate, aluminum alloy plate or mixtures thereof;
wherein said polyester has a T_{g} of 55 to 120° C.;
wherein said polyester has a Tₘ of 220 to 265° C. and
wherein said film has a strain induced strain induced crystallinity of 5 to 30% when stretched at a temperature from about 20° C. to about 50° C. above the T_{g} of the polyester.
